(19) United States
(12) Patent Application Publication
(10) Pub. No.: US 2001/0043791 A1
(43) Pub. Date: Nov. 22, 2001

(54) ARRANGEMENT FOR RECORDING AND REPRODUCING STANDARD AND SLOW-MOTION VIDEO SIGNALS

(76) Inventors: HENRIK FEGESCH, DARMSTADT (DE); WILFRIED WUST, FISCHBACHTAL/STEINAU (DE)

Correspondence Address: CORPORATE PATENT COUNSEL, U S PHILIPS CORPORATION, 580 WHITE PLAINS ROAD, TARRYTOWN, NY, 10591

(21) Appl. No.: 08/878,361

(22) Filed: Jun. 18, 1997

(30) Foreign Application Priority Data
Jul. 12, 1996 (DE) 19628187.3

(51) Int. Cl. H04N 5/76; H04N 5/225; H04N 9/47

(52) U.S. Cl. 386/67; 386/117; 348/148

(57) ABSTRACT

The invention relates to an arrangement for recording and reproducing video signals, comprising at least a camera unit (10, 12; 14, 15) for generating video signals, at least a recording/reproducing device (22) adapted to the generated video signals, and at least a slow-motion programmer (18, 19) for controlling the recording/reproducing device (22) during slow-motion operation. To reduce the number of components for slow-motion recordings and provide the simultaneous possibility of superslow-motion operation, the invention is characterized in that the camera unit (10, 12; 14, 15) comprises a device (13) for switching the frame frequency from a standardized value to a value which is higher than this standardized value, and a RAM recorder (22) is provided as a recording/reproducing device which records and reproduces the video signals generated by the camera unit (10, 12; 14, 15) as digital signals.

The invention relates to an arrangement for recording and reproducing video signals, comprising

at least a camera unit for generating video signals,

at least a recording/reproducing device adapted to the generated video signals, and

at least a slow-motion programmer for controlling the recording/reproducing device during slow-motion operation.

Such a camera unit may be, for example, either a camera head (stand-alone) or a camera head with a base station.

Arrangements of the type described in the opening paragraph are known. They are preferably used in mobile units with which, for example sports events such as soccer matches or tennis tournaments can be transmitted on-line. With the aid of the camera units used for this purpose, the event is, for example, recorded locally and transmitted live to the viewers. The camera units operate at a standardized frame frequency of 50 Hz. In this mode of operation, the event is thus permanently recorded, but slow-motion recordings for given scenes can only be played from the full tape and transmitted after the end of the event.

However, at the transmission of a given event from a mobile unit, a plurality of camera units operating at the standard frame frequency of 50 Hz are used as special slow-motion camera units. Normally, a corresponding, adapted magnetic tape recording/reproducing device (MAZ) is allocated to each slow-motion camera unit. With the aid of such slow-motion camera units, given picture scenes, for example goal scenes can be reproduced in slow motion during the match for the television viewers. At the start of a given picture scene, an operator activates a key of a control device so as to set a time mark. At the end of this scene, activation of another key causes the magnetic tape to be rewound to a position which is a few seconds before the time mark set. It is thereby achieved that the pictures introducing the scene in question are also reproduced when the recorded scene is subsequently replayed in slow motion. A drawback of the use of such magnetic tape devices is that some seconds until the starting position elapse when the magnetic tape is being rewound. These seconds cannot be used for slow-motion replay. In these seconds, the magnetic tape device blocked by the rewinding process can neither make any recordings of scenes which immediately follow the scene in question and may also be interesting for slow-motion replay.

For rapid actions, for example, in tennis matches, the conventional slow-motion technique operating at the standard frame frequency of 50 Hz is inadequate. To present recordings in extreme slow motion to the television viewers, special slow-motion apparatuses are used for this purpose which enhance the motion resolution limited by the television transmission standard and are not bound to such a standard. The camera units of such slow-motion apparatuses operate at a frame frequency of 150 Hz which is thus considerably higher than the standardized frame frequency of 50 Hz. The high-resolution video signal generated by such a special camera unit is also applied to a recording/reproducing magnetic tape apparatus which, however, must be adapted to the special camera unit using a frame frequency of 150 Hz. This magnetic tape apparatus records the high-resolution video signal generated by the camera unit, and the recorded video signal is reproduced in slow motion with a time offset. Such special slow-motion apparatuses, which have become known as superslow-motion apparatuses, are very expensive and elaborate and are therefore only used in a simple implementation in conventional mobile units in addition to several normal slow-motion camera units.

U.S. Pat. No. 4,685,002 discloses a slow-motion television system using a plurality of cameras and storage elements which are allocated to the cameras. With such a construction, direct access to the stored data is not possible.

It is an object of the invention to reduce the number of components in an arrangement of the type described in the opening paragraph, while simultaneously providing the possibility of recording and transmitting video signals in the slow-motion or superslow-motion technique.

According to the invention, this object is solved in that

the camera unit comprises a device for switching the frame frequency from a standardized value to a value which is higher than said standardized value, and

a RAM recorder is provided as a recording/reproducing device which records and reproduces the video signals generated by the camera unit as digital signals.

As already stated above, such a camera unit may be, for example a stand-alone camera head or a camera head with a base station. The switching device according to the invention may be arranged, for example, in the camera head or in the base station.

Since the camera unit is provided with a device for switching the frame frequency, it has the advantage that only one type of camera unit is required, both for normal television recordings and slow-motion recordings in the superslow-motion technique. This is particularly advantageous in the spatially small mobile units. Dependent on its application, the switchable camera unit may thus be used as a conventional camera unit supplying a standard television signal or as a slow-motion camera unit supplying a non-standard video signal. The space which would otherwise be generally used for the above-mentioned special slow-motion camera units with the associated amplifiers and control desks can thus be saved.

Since a RAM recorder instead of a magnetic tape apparatus is used as a recording and reproducing device, the further advantage is obtained that slow-motion scenes in superslow-motion quality can be presented on-line and without any loss of time to the television viewers. The data of the high-resolution video signals which are continually written on the disc store can be considered as virtual files which, by selection by means of the slow-motion programmer, can be immediately read again in the form of a non-linear editing and transmitted as slow-motion pictures. A further advantage is that no picture scenes are lost when they are being shown in slow motion, because rewinding is not necessary.

An embodiment of the invention is characterized in that the RAM recorder is a disc store having a plurality of channels which can each be allocated to a separate and individual camera unit. This yields the advantage that only one recording/reproducing device whose channels are allocated to the individual camera units is provided for a plurality of camera units. This results in a considerable space saving, as compared with arrangements in which a separate magnetic tape recording apparatus must be allocated to each camera unit. This is particularly advantageous in mobile units, because several slow-motion devices are regularly installed in such spatially small units for producing TV programs of sports events.

The invention thus yields the advantage that the camera units used can be operated either at the standardized frame frequency or, after switching, at the higher frame frequency of, for example 150 Hz required for superslow-motion operation, while all camera units can be simultaneously switched to a single recording/reproducing device. During transmission of, for example, important sports events, this provides the possibility of operating a given number of camera units at the standardized frame frequency while another number of cameras is switched to the higher frame frequency so as to be able to present recordings in superslow motion to the television viewers. The possibility of switching, on the one hand, and the use of a single recording/reproducing device for all camera units, on the other hand, thus precludes the hitherto conventional large number of components for a special camera used in superslow motion with an adapted magnetic tape recording device.

These and other aspects of the invention are apparent from and will be elucidated with reference to the embodiments described hereinafter.

In the drawings:

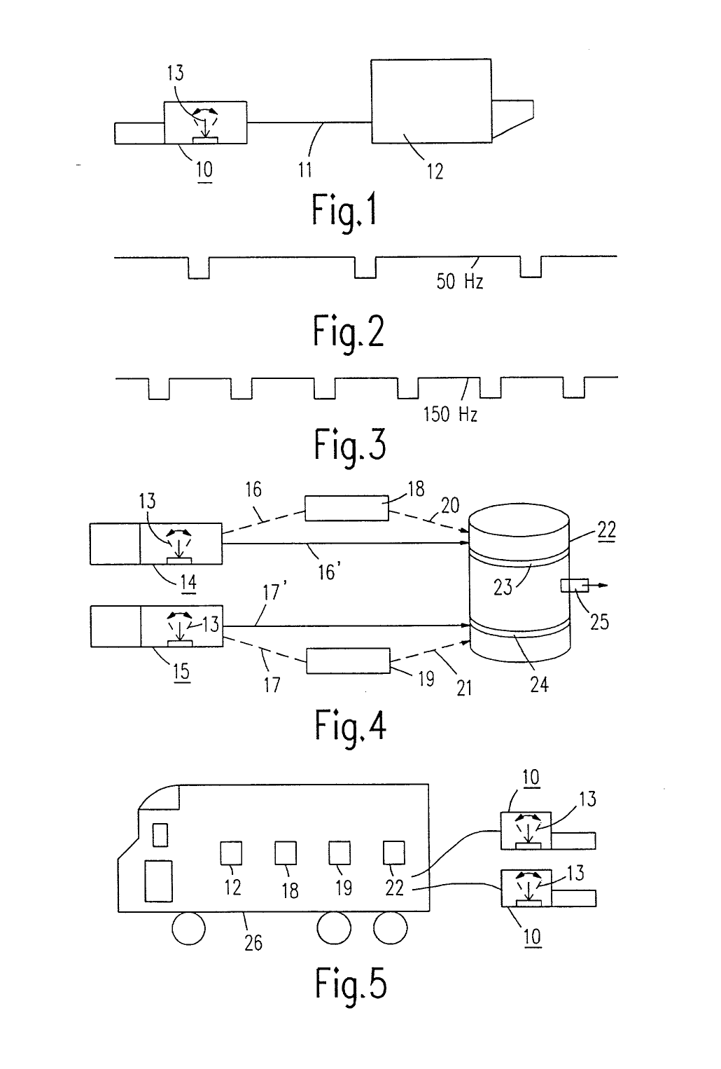

FIG. 1 shows diagrammatically a switchable camera unit,

FIGS. 2 and 3 show two signal sequences at different frequencies,

FIG. 4 shows an arrangement for recording and reproducing video signals by means of two camera units and an associated RAM fixed disc recorder, and

FIG. 5 shows diagrammatically a mobile unit with the devices shown in FIGS. 1 and 3.

FIG. 1 shows a camera unit comprising a camera head 10 and a base station 12 which are interconnected via a cable 11. The camera head 10 comprises a switching device 13 for switching from a standardized frame frequency of, for example 50 Hz to an increased frame frequency of, for example 150 Hz for superslow-motion recordings.

FIG. 2 shows a signal sequence for a standard frame frequency of 50 Hz and FIG. 3 shows a signal sequence for slow motion at a frame frequency of 150 Hz.

FIG. 4 shows an arrangement for recording and reproducing video signals by means of two camera units 14, 15 which, by means of switching devices 13, are switchable from a standard frame frequency of 50 Hz to an increased frame frequency of 150 Hz. The camera units 14, 15 are connected via cables 16, 17 to slow-motion programmers 18, 19 which are connected to a RAM recorder 22 via cables 20, 21. There is also a direct connection between the camera units 14, 15 and the RAM recorder 22 via cables 16′, 17′. The recorder 22 is used as a recording/reproducing device which records and reproduces the video signals generated by the camera units 14, 15 as digital signals. In slow-motion operation, the high-resolution video signals generated by the camera units 14, 15 are applied to the RAM recorder 22 which is controlled by the slow-motion programmers 18, 19. The high-resolution signals applied to the recorder 22 are stored by selection by means of the slow-motion programmers 18, 19 in channels 23, 24 which are diagrammatically shown and, as denoted by the reference numeral 25, can be immediately read out again and transmitted as slow-motion pictures.

FIG. 5 shows diagrammatically a mobile unit 26 accommodating devices (for example base station 12, slow-motion programmers 18, 19, RAM recorder 22) and camera heads 10 outside the unit 26.

1. An arrangement for recording and reproducing video signals, comprising
at least a camera unit (10, 12; 14, 15) for generating video signals,
at least a recording/reproducing device (22) adapted to the generated video signals, and
at least a slow-motion programmer (18, 19) for controlling the recording/reproducing device (22) during slow-motion operation, characterized in that
the camera unit (10, 12; 14, 15) comprises a device (13) for switching the frame frequency from a standardized value to a value which is higher than said standardized value, and
a RAM recorder (22) is provided as a recording/reproducing device which records and reproduces the video signals generated by the camera unit (10, 12; 14, 15) as digital signals.

2. An arrangement as claimed in claim 1, characterized in that the RAM recorder is a disc store (22) having a plurality of channels (23, 24) which can each be allocated to a separate and individual camera unit (14, 15).

3. An arrangement as claimed in claim 1 or 2, characterized in that the device (13) is used for switching the frame frequency from the standardized value of 50 Hz to a frame frequency of 150 Hz.

4. An arrangement as claimed in any one of claims 1 to 3, characterized by its use in a mobile unit (26).
